(19) United States
(12) Patent Application Publication
(10) Pub. No.: US 2013/0215810 A1
(43) Pub. Date: Aug. 22, 2013

(54) METHOD AND DEVICE FOR TRANSMITTING AN IPV6 OVER LOW POWER WIRELESS PERSONAL AREA NETWORK DATA PACKET

(71) Applicants: Bin Wang, Shanghai (CN); Shuigen Yang, Shanghai (CN); Haibo Wen, Shanghai (CN); Zheng Liang, Shanghai (CN)

(72) Inventors: Bin Wang, Shanghai (CN); Shuigen Yang, Shanghai (CN); Haibo Wen, Shanghai (CN); Zheng Liang, Shanghai (CN)

(73) Assignee: ALCATEL-LUCENT, Paris (FR)

(21) Appl. No.: 13/881,258

(22) PCT Filed: Oct. 25, 2011
(86) PCT No.: PCT/IB11/02958

§ 371 Date: Apr. 24, 2013

(30) Foreign Application Priority Data
Nov. 3, 2010 (CN) 201010530632.0

(51) Int. Cl. H04L 12/56; H04W 4/00

(52) U.S. Cl. CPC H04L 45/74; H04W 4/008
USPC 370/311

(57) ABSTRACT

In one embodiment, a first node as a source node obtains personal area network identifiers of the first node and a second node respectively; and then fills the personal area network identifiers of the first node and the second node and 6LoWPAN-message-type information in a 6LoWPAN data packet and sends them to the edge router. After receiving the 6LoWPAN data packet, the edge router judges 6LoWPAN-message-type information of the data packet. When the 6LoWPAN-message-type information indicates that the data packet is sent to another 6LoWPAN subnet, the 6LoWPAN data packet is encapsulated in an IP data packet and sent to a backbone network router. The backbone network router and the edge router of the subnet in which the destination node is located, respectively route the data packet according to the personal area network identifier of the destination address.

### FIELD OF THE INVENTION

The present invention relates to IPv6 over Low power Wireless Personal Area Network, especially to a method and device for transmitting an IPv6 over Low power Wireless Personal Area Network data packet.

### BACKGROUND OF THE INVENTION

6LoWPAN (IPv6 over Low power Wireless Personal Area Networks) enables the transmission of IPv6 data packets over 802.15.4 links by introducing an adaptation layer between the data link layer and the network layer of the IP stack so as to dramatically reduce IP overhead. The adaptation layer is a standard proposed by IETF (Internet Engineering Task Force). The standard provides with header compression to reduce transmission overhead, and also provides with fragmentation of the data packet to support the IPv6 minimum MTU (Maximum Transmission Unit) requirement, wherein an IPv6 MTU has at least 1280 Bytes and an MTU of an IEEE 802.15.4 Protocol data packet has 127 Bytes, thus the fragmentation is necessary to perform when transforming the IPv6 data packet into the IEEE 802.15.4 Protocol data packet, and the adaptation layer further supports forwarding of layer 2 and forwarding of IPv6 data packet over multiple hops. 6LoWPAN achieves low overhead by applying cross-layer optimizations. The 6LoWPAN network uses information in the link and adaptation layers to compress headers of the network layer and the transport layer. For IPv6 extension headers, the 6LoWPAN network employs the header stacking principle to separate the orthogonal concepts and keep the header small and easy to parse.

The 6LoWPAN network may interconnect with other IP networks by using IP routers. As shown in FIG. 1, 6LoWPAN subnets, acting as stub networks, typically operate at the edge of a network. 6LoWPAN subnets may be connected to other IP networks via one or more edge routers which forward IP data packets between different media. Interconnection with other IF networks may be provided via any link, such as Ethernet, Wi-Fi, GPRS, or satellite networks etc.

In large scale sensor application networks such as intelligent transportation, asset tracking, environment monitoring etc, the sensor network may comprise one or more distributed small sensor subnets while the sensor gateways (or Edge Router) are connected to a central controller (or Backbone Router) via backhaul links (usually IP link). FIG. 2 shows a 6LoWPAN IPv6 network comprising one or more 6LoWPAN subnets.

In the prior art, the usually considered operation scenario in 6LoWPAN network is the communication inside the same link (link local) or the communication with an IP node outside the 6LoWPAN network namely global communication. IETF work group has proposed RFC4944 and draft-ietf-6lowpan-hc-08 draft to solve the aforesaid problems.

### SUMMARY OF THE INVENTION

However, in large scale sensor applications, the collaboration among sensor nodes in different 6LoWPAN subnets is very common, for example, for large scale environment monitoring, public security monitoring, public facilities tracking etc, because the scope to be detected is large, the collaboration among a plurality of sensors crossing different 6LoWPAN subnets is needed, which means the 6LoWPAN intra-subnet communication should also be considered. However, neither the existing RFC4944 protocol nor the draft-ietf-6lowpan-hc draft has proposed a solution suitable for this cross-subnet application scenario, for example, corresponding compression format. Therefore, the present invention proposes a compression format for IPv6 Data packets in 6LowPAN subnet to be used for the cross-6LowPAN subnet transmission for IPv6 Data packets.

In the existing two compression formats, RFC4944 specified LOWPAN_HC1 header compression format and draft-ietf-6lowpan-hc specified LOWPAN_IPHC header compression format.

When using LOWPAN_HC1 encoding format, since the local link address is not global, the address of the destination node can only be identified by its full 128 bit IPv6 address which carried in inline mode. However, this address encoding method greatly wastes the limited 127 bytes space of an 802.15.4 data packet, so it is not an efficient and feasible way.

In LOWPAN_IPHC solution, CID (Context Identifier Extension) may be utilized to map the global IPv6 prefix of the destination node. But this solution has the following limits of:

1. limited CID number. The CID field has only 8 bits, which means there are only 4 bits SCI (Source Context Identifier) and 4 bits DCI (Destination Context Identifier), that is, only 16 SCIs and 16 DCIs can be identified. These SCIs and DCIs are used for multicast IPv6 prefix and global communication IPv6 prefix, so these SCI and DCI are not sufficient in large-scale LoWPAN network.

2. the same global prefix assignment in the same subnet. Generally, the nodes in the same subnet have the same global IPv6 prefix. Therefore, when CID is not sufficient, extra subnet prefix is distributed in order to identify different 6LoWPAN subnets.

3. the overhead of CID management. In order to map the CID with IPv6 prefix, the nodes must have the mapping table which is distributed to nodes by the edge router. Therefore, the CID distribution process will bring more overhead, and this solution is inefficient when the CID mapping changes frequently.

Therefore, in order to solve the problem that the aforesaid two address compression methods are inefficient in the prior art, the present invention proposes to identify the addresses of 6LoWPAN data packets by using personal area network identifiers.

According to the first aspect of the present invention, there is provided a method of communicating with a second node, in a first node of a 6LoWPAN subnet, wherein the method comprises the following steps of: obtaining personal area network identifiers of the first node and the second node respectively; filling the personal area network identifiers of the first node and the second node and 6LoWPAN-message-type information in a 6LoWPAN data packet, wherein the personal area network identifier of the first node is used for indicating a source address of the 6LoWPAN data packet, the personal area network identifier of the second node is used for indicating a destination address of the 6LoWPAN data packet, the 6LoWPAN-message-type information is used for identifying that the first node and the second node are located in different 6LoWPAN subnets; sending the filled 6LoWPAN data packet.

According to the second aspect of the present invention, there is provided a method of routing a 6LoWPAN data packet from a first node, in an edge router located at the edge of a 6LoWPAN subnet, wherein the method comprises the following steps of: receiving the 6LoWPAN data packet from the first node; judging whether the 6LoWPAN data packet is sent to another 6LoWPAN subnet, according to 6LoWPAN-message-type information in the 6LoWPAN data packet; encapsulating the 6LoWPAN data packet in an IP data packet when the 6LoWPAN data packet is sent to another 6LoWPAN subnet; sending the encapsulated IP data packet to a next-hop network equipment.

According to the third aspect of the present invention, there is provided a method of routing a data packet from a 6LoWPAN subnet, in a router of a backbone network, wherein the method comprises the following steps of: receiving an IF data packet from the 6LoWPAN subnet; decapsulating the IP data packet to obtain a personal area network identifier of a destination address in the IP data packet; determining a next-hop network equipment according to the personal area network identifier; forwarding the IP data packet to the next-hop network equipment.

According to the fourth aspect of the present invention, there is provided a method of routing an IP data packet from a backbone network, in an edge router located at the edge of a 6LoWPAN subnet, wherein the method comprises the following steps of: receiving the IP data packet from the backbone network; obtaining a 6LoWPAN data packet encapsulated in the IP data packet according to the IP data packet, and extracting an interface identifier of a destination address in a header of the 6LoWPAN data packet, wherein the interface identifier indicates that the destination address of the 6LoWPAN data packet is a second node; sending the 6LoWPAN data packet to the second node.

According to the fifth aspect of the present invention, there is provided a first device for communicating with a second node, in a first node of a 6LoWPAN subnet, wherein the first device comprises: a first obtaining means, for obtaining personal area network identifiers of the first node and the second node respectively; a filling means, for filling the personal area network identifiers of the first node and the second node and 6LoWPAN-message-type information in a 6LoWPAN data packet, wherein the personal area network identifier of the first node is used for indicating a source address of the 6LoWPAN data packet, the personal area network identifier of the second node is used for indicating a destination address of the 6LoWPAN data packet, the 6LoWPAN-message-type information is used for identifying that the first node and the second node are located in different 6LoWPAN subsets; a first sending means, for sending the filled 6LoWPAN data packet.

According to the sixth aspect of the present invention, there is provided A second device for routing a 6LoWPAN data packet from a first node, in an edge router located at the edge of a 6LoWPAN subnet, wherein the second device comprises: a first receiving means, for receiving the 6LoWPAN data packet from the first node; a judging means, for judging whether the 6LoWPAN data packet is sent to another 6LoWPAN subnet, according to 6LoWPAN-message-type information in the 6LoWPAN data packet; an encapsulating means, for encapsulating the 6LoWPAN data packet in an IP data packet when the 6LoWPAN data packet is sent to another 6LoWPAN subnet; a second sending means, for sending the encapsulated IP data packet to a next-hop network equipment.

According to the seventh aspect of the present invention, there is provided a third device for routing a data packet from a 6LoWPAN subnet, in a router of a backbone network, wherein the third device comprises: a second receiving means, for receiving an IP data packet from the 6LoWPAN subnet; a second obtaining means, for decapsulating the IP data packet to obtain a personal area network identifier of a destination address in the IP data packet; a determining means, for determining a next-hop network equipment according to the personal area network identifier; a third sending means, for forwarding the IP data packet to the next-hop network equipment.

According to the eighth aspect of the present invention, there is provided a fourth device for routing an IP data packet from a backbone network, in an edge router located at the edge of a 6LoWPAN subnet, wherein the fourth device comprises: a third receiving means, for receiving the IP data packet from the backbone network; a third obtaining means, for obtaining a 6LoWPAN data packet encapsulated in the IP data packet according to the IP data packet, and extracting an interface identifier of a destination address in a header of the 6LoWPAN data packet, wherein the interface identifier indicates that the destination address of the 6LoWPAN data packet is a second node; a fourth sending means, for sending the 6LoWPAN data packet to the second node.

By using the solution of the present invention, there is provided a compression format for the header in 6LoWPAN, which can greatly improve the efficiency of the communications among different 6LoWPAN subnets in the same backbone network, and can also extend the communication application scenarios of 6LoWPAN, and thus the deployment of the large scale sensor network can be allowed.

### BRIEF DESCRIPTION OF THE DRAWINGS

By reading the detailed description of the non-limiting embodiments with reference to the following drawings, other features, objects and advantages of the present invention will become apparent.

FIG. 1 shows a schematic diagram of a network structure comprising 6LoWPAN subnets in the prior art;

FIG. 2 shows a schematic diagram of a network topology according to a detailed embodiment of the present invention;

FIG. 3 shows a structure diagram of header compression according to a detailed embodiment of the present invention;

FIG. 4 shows a flowchart of a system method according to a detailed embodiment of the present invention;

FIG. 5 shows a block diagram of device according to a detailed embodiment of the present invention.

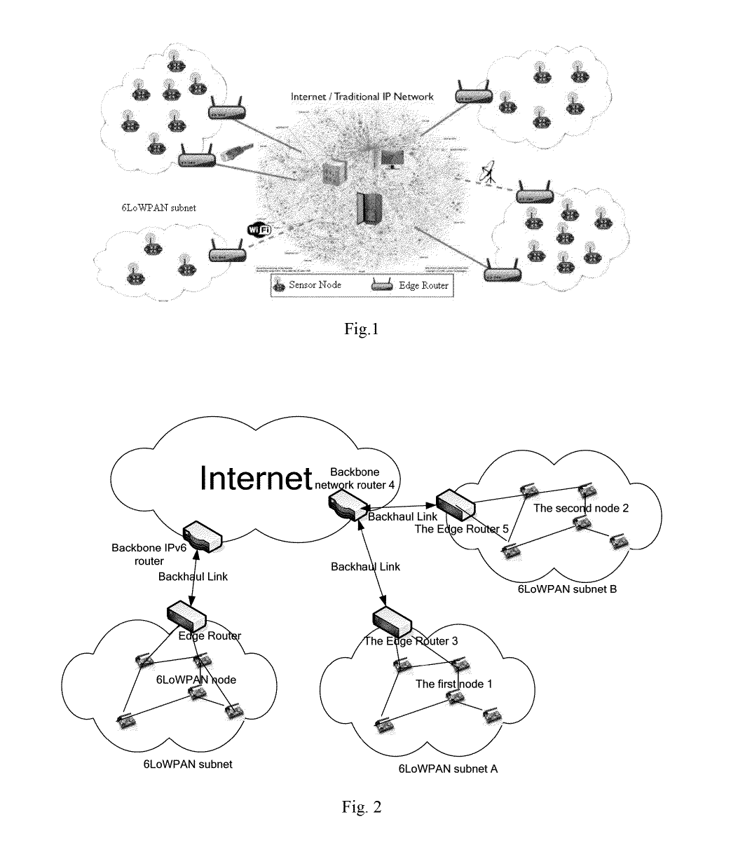

In drawings, same or similar reference signs refer to the same or similar step feature or device/module.

### DETAILED DESCRIPTION OF EMBODIMENTS

A most critical problem of the communication among cross-6LoWPAN subnet nodes is how to use relative small Byte to uniquely identify the 6LoWPAN nodes that interactive with each other. Although different 6LoWPAN nodes have different IIDs (interface identifier) in the same 6LoWPAN network, 6LoWPAN nodes in different 6LoWPAN networks may have the same IID.

Wherein, IID has two formats. It may either obtained based on the EUI-64 identifier allocated to the IEEE802.15.4 equipment node or be obtained based on the 16 bit short address.

To be specific, IID may be generated according to the EUI-64 identifier on the basis of “IPv6 over Ethernet” of RFC2464.

All of the 802.15.4 equipments have IEEE EUI-64 addresses, and furthermore, the node equipment may have also the 16 bit short address. Therefore, false-48 bits address will be formed under these conditions. Firstly, the leftmost 32 bits forms 32 bits prefix by connecting 16 bits “0” and 16 bits PAN ID. When PAN ID can not be obtained, the previous 32 bits are all filled by “0” and connected to the 16 bit short address to form a 48 bits address, and then IID is generated on the basis of the “IPv6 over Ethernet” standard of RFC2464. However, in the generated IID, “U/L (Universal/Local)” bit should be set with “0” to indicate that the value is not globally unique.

The 6LoWPAN system consists of equipments nodes which are called nodes for short. These nodes comprise FFD (Full Function Device) and RFD (Reduced Function Device). A 6LoWPAN network should comprise at least one FED as the PAN coordinator.

After allocating new PAN ID to one of sub-nodes (it must also be FFD), the PAN coordinator can extend the star topology of the 802.15.4 network to create PAN cluster in which only coordinator nodes may exchange information. It should be noted that the standard do not directly support routing. Once the PAN coordinator finishes initiation, a PAN ID must be selected for the network of the PAN coordinator as network identifier. The PAN ID may be predefined by person.

Here it needs to be illustrate that the PAN ID may be obtained by listening IDs of other networks and then selecting a non-conflicting PAN ID. The PAN coordinator may scan a plurality of frequency channels, and certainly research and development personnel may also specify the equipment to preferentially scan the specific channel to determine the PAN ID which does not conflict with other networks.

From the aforesaid description it may be seen that the selection of PAN ID should avoid confliction, therefore, each 6LoWPAN subnet has respective PAN ID, and PAN IDs of each extended subnet dominated by the same backbone IPv6 router differ from each other, therefore, PAN ID plus IID may uniquely identify all 6LoWPAN nodes in all IPv6 subnets.

As shown in FIG. 2, the first node 1 and the second node 2 are located in different 6LoWPAN subnets. Wherein, the first node 1 is located in 6LoWPAN subnet A, and the second node 2 is located in 6LoWPAN subnet B. The first node 1 in 6LoWPAN subnet A is connected to the backbone router 4 via the edge router 3, and the first node 2 in 6LoWPAN subnet B is connected to the backbone router 4 via the edge router 5, thereby the first node 1 may communicate with the second node 2.

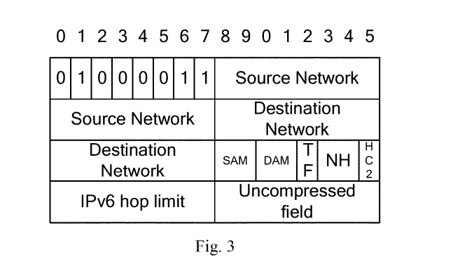

According to a detailed embodiment of the present invention, the present invention defines a new data compression format, and the compression format comprises three parts, as shown in FIG. 3.

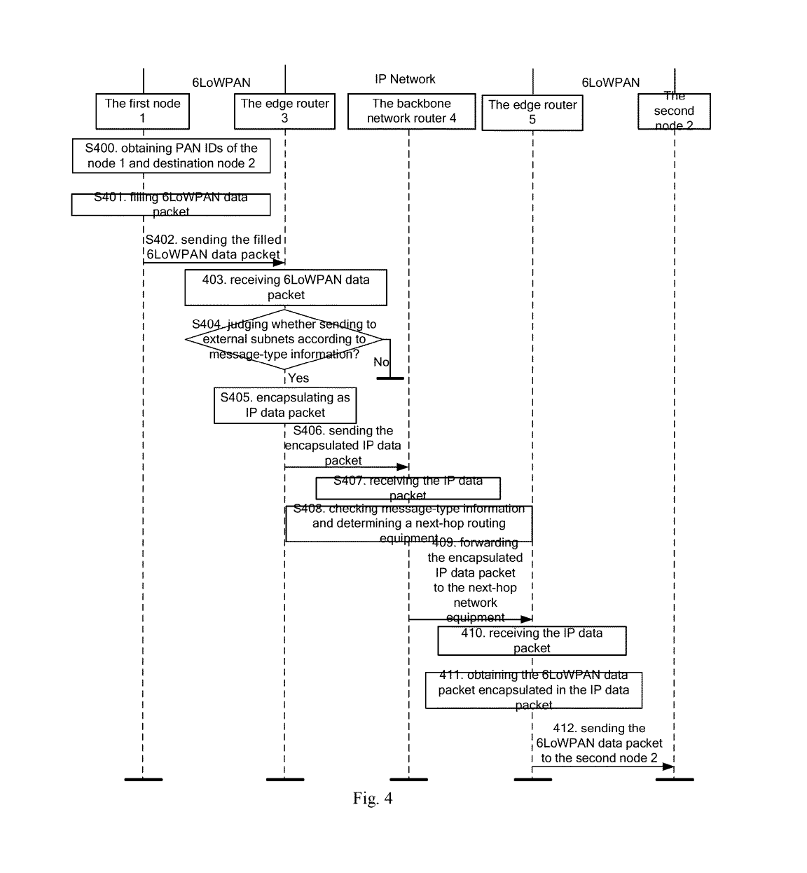

1. New Message Type
That is Dispatch type to identify an intra-subnet communication type. As shown in FIG. 4, the first 8 bit of the compressed header is message type. For such message type, the first three bits defined in draft-ietf-6lowpan-hc are 011, and in RFC4944, 01000001 denotes an uncompressed IPv6 address, 01000010 denotes LOWPAN_HC1. Therefore, the reserved 01000011 may be used to denote that a compressed IPv6 data packet for cross-subnet type is used.

2. SN (Source Network) Field and DN (Destination Network) Field
SN field and DN field are used to identify the two interaction 6LoWPAN subnet in a same IEEE 802.15.4 network. Wherein the PAN ID has 16 bits, and SN field and DN field use PAN ID to identify the subnet, therefore, the Backbone Router needs to allocate the PAN ID to its subnets without duplication, for example, by means of confliction detection mechanism etc.

3. IPv6 Prefix Definition
The application layer program commonly uses IPv6 address to identify source nodes and destination nodes, thus an IPv6 address mapping scheme needs to be designed. The IPv6 Suffix is the 64 bit IID of the 6LoWPAN node (64 bit EUID or extended from 16 bit short 802.15.4 address). The IPv6 Prefix is a link local address starting from FE80:/10. In cross-subnet communication, IPv6 Prefix should identify the source and destination 6LoWPAN network, thus the IPv6 Prefix of the 6LoWPAN node is FE80::/10 plus the 16 bit PAN ID of the network.

The new defined header compression format is shown in FIG. 3. Wherein, SN identifies the source network and is 16 bit PAN ID of source node's IEEE 802.15.4 network; DN identifies the destination network and is 16 bit PAN ID of destination node's IEEE 802.15.4 network.

SAM denotes Source Address Mode, wherein:

00 denotes 16 bits IID elided (derivable from the corresponding link-layer address such as via MAC address);

01 denotes 64 bits IID elided (derivable from the corresponding link-layer address such as via MAC address);

10 denotes 16 bits IID carried in-line;

11 denotes 64 bits IID carried in-line.

DAM denotes Destination Address Mode, wherein:

00 denotes 16 bits IID elided (derivable from the corresponding link-layer address such as via MAC address);

01 denotes 64 bits BD elided (derivable from the corresponding link-layer address such as via MAC address);

10 denotes 16 bits IID carried in-line;

11 denotes 64 bits IID carried in-line.

TF: Traffic class and Flow label (1 bit), wherein:

0: not compressed; full 8 bits for Traffic Class and 20 bits for Flow Label are sent;

1: Traffic Class and Flow Label are set with “0”.

NH: Next Header (2 bits)

00: not compressed; full 8 bits are sent

01: UDP

10: ICMP

11: TCP

HC2 encoding (1 bit)

0: No more header compression bits;

1: 6LOWPAN_SUBNET compression immediately followed by more header compression bits per HC2 encoding format. NH determines which of the possible HC2 encodings (for example, UDP, ICMP, or TCP encodings) is applied.

HLIM: Hop Limit (8 bits)

Uncompressed IPv6 Hop Limit

Hereinafter, a flowchart of the system method shown in FIG. 4 according to a detailed embodiment of the present invention is described in combination with FIG. 3. As shown in FIG. 4, firstly, in the step S400, the first node 1 obtains PAN IDs of the node 1 and a destination node, the destination node is just the second node 2. According to the aforesaid description, the PAN ID may be the PAN ID selected for the network by PAN coordinator while finishing the initiation of the network, or be the PAN ID predefined by person.

For example, the first node 1 obtains that the IPv6 address of the link subnet of the first node 1 is FE80::AC01:0217:3 B00:1111:2222 and the IPv6 address of the link subnet of the second node 2 is FE80::BD02:0423:3F02:3333:4444. According to the IPv6 address, the first node 1 obtains that the PAN ID of the first node 1 is 0xAC01 and the PAN ID of the second node 2 is 0xBD02. Moreover, the next-hop network equipment of the first node 1 is the edge router 3, thus the first node 1 does not need to embed the IID in the uncompressed field, and the next-hop router equipment may directly extract the IDD of the first node from the link layer address.

Then, in the step S401, the first node 1 fills the PAN IDs of the first node 1 and the second node 2 and 6LoWPAN-message-type information in a 6LoWPAN data packet, wherein the PAN ID of the first node 1 is used for indicating a source address of the 6LoWPAN data packet, the PAN ID of the second node 2 is used for indicating a destination address of the 6LoWPAN data packet, the 6LoWPAN-message-type information is used for identifying that the first node 1 and the second node 2 are located in different 6LoWPAN subnets.

For example, in a detailed embodiment, by the steps of listening to broadcasting message or router discovery etc, it is found that the first node 1 is directly connected with the edge router 3. Therefore, the IID of the first node 1 may be directly extracted from the MAC layer address, and thus the source address needs not comprise explicit IID of the first node 1. Therefore, the first node 1 directly fills the PAN ID 0xAC01 of the first node 1, the PAN ID 0xBD02 of the second node 2 and the 6LoWPAN-message-type information in the 6LoWPAN data packet.

Then, in the step S402, the first node 1 sends the filled the 6LoWPAN data packet.

For the scenario that the source address does not need to explicitly comprise IID, the PAN ID only needs to occupy 4 Bytes in the source network and destination network fields. However, for the traditional RFC4944 standard, in order to indicate the cross-subnet destination address, the source address and destination address need to occupy 32 Bytes. Therefore, comparing with the traditional RFC4944 standard, the 6LoWPAN header format proposed by the invention greatly reduces the signaling overhead.

In a varied embodiment, prior to the step S400, if by the steps of listening to broadcasting message or router discovery etc, the first node 1 finds that it is not directly connected with the edge router 3, that is, the first node 1 is connected with the edge router 3 via multi-hop routing equipments (this scenario is not shown in FIG. 2), then now the IID can not be extracted from the MAC layer address, therefore, the first node 1 also needs to include IIDs of the first node 1 and the second node 2 in the header of the 6LoWPAN data packet. That is, the 6LoWPAN header generated by the first node 1 also needs to comprise IIDs of the source address and destination address besides PAN IDs of the source address and destination address as well as the 6LoWPAN-message-type information, and the varied embodiment is not shown in FIG. 4.

To be specific, steps S400-S402 are replaced by the following steps S400′-S402′. Firstly, in the step S400′, the first node 1 also needs to obtain the IIDs of the first node 1 and the second node 2 besides the PAN IDs of the first node 1 and the second node 2. For example, the first node 1 obtains that the IPv6 address of the link subnet of the first node 1 is FE80::AC01:0217:3 B00:1111:2222 and the IPv6 address of the link subnet of the second node 2 is FE80::BD02:0423:3F02:3333:4444. Then, the first node 1 respectively parses IIDs and PAN IDs of the first node 1 and the second node 2. For example, the first node 1 obtains that the IID of the first node 1 is 0217:3 B00:1111:2222, the PAN ID of the first node 1 is 0xAC01; the IID of the second node 2 is 0423:3F02:3333:4444, the PAN ID of the second node 2 is 0xBD02.

Then, in the step S401′, the first node 1 fills the PAN ID and IID of the first node 1, the PAN ID and IID of the second node 2 as well as the message-type information in the 6LoWPAN data packet, wherein the PAN ID and IID of the first node 1 is used for indicating the source address of the 6LoWPAN data packet, and the PAN ID and IID of the second node 2 is used for indicating the destination address of the 6LoWPAN data packet. Therefore, the source network field and the destination network field, which the first node 1 fills in the header of the 6LoWPAN data packet, are respectively 0xAC01 and 0xBD02.

Then, the first node 1 sets the SA and DA fields in the compressed IPv6 header as 11,11, referring to table 2, which means the source address and destination address are identified by 64 bits IID which carried in inline mode. Therefore, the source no and destination IID in uncompressed field are respectively set as 0217:3 B00:1111:2222 and 0423:3F02:3333:4444.

Then, in the step S402′, the first node 1 sends the filled 6LoWPAN data packet.

For the scenario that the IID needs to be explicitly comprised in the header of the 6LoWPAN data packet, the PAN IDs of the first node 1 and the second node 2 respectively occupies 2 Bytes, in addition, the IIDs of the first node 1 and the second node 2 respectively occupies 8 Bytes, therefore, in order to identify the source address and the destination, 20 Bytes are needed totally, which is reduced clearly comparing with the needed 32 Bytes based on FRC4944 protocol.

Then, in the step S403, the edge router 3 receives the 6LoWPAN data packet from the first node 1.

Then, in the step S404, according to the 6LoWPAN-message-type information in the 6LoWPAN data packet, the edge router 3 judges whether the 6LoWPAN data packet is sent to another 6LoWPAN subnet, that is, the edge router 3 judges whether the bits in the Dispatch field are the defined cross-subnet communication bits identifier.

In the step S405, if the edge router 3 obtains that the bits in the Dispatch field are 01000011, then the edge router 3 judges that the 6LoWPAN data packet is sent to another 6LoWPAN subnet, and then the edge router 3 encapsulates the 6LoWPAN data packet in the IP data packet.

In the step S406, the edge router 3 sends the encapsulated IP data packet to a next-hop network equipment.

If the edge router obtains that the bits in the Dispatch field are other values except for 01000011 in the step S405′, then the edge router 3 routes the data packet according to the predetermined routing rule, for example, the value in the Dispatch field is 01000010, which indicates that the data packets is of LOWPAN_HC1 type, then the edge router 3 routes the 6LoWPAN data packet according to the RFC4944 standard.

Then, in the step S407, the router 4 in a backbone network receives the IP data packet which is from the 6LoWPAN subnet A and forwarded by the edge router 3 of the 6LoWPAN subnet A.

Then, in the step S408, the router 4 in the backbone network de-capsulates the IP data packet to obtain a PAN ID of a destination address in the IP data packet, for example, the PAN ID of the destination address, obtained by the router 4 in the backbone network, is 0xBD02, then the router 4 in the backbone network determines the next-hop network equipment according to the PAN ID 0xBD02, for example, the router 4 in the backbone network determines that the corresponding 6LoWPAN subnet is the subnet B, therefore, the next-hop routing equipment is the edge router 5 of the 6LoWPAN subnet B.

Then, in the step S409, the router 4 in the backbone network forwards the IP data packet to the determined next-hop network equipment, for example the edge router 5.

Then, in the step S410, the edge router 5 receives the IP data packet from the backbone network.

Then, in the step S411, the edge router 5 obtains the 6LoWPAN data packet encapsulated in the IP data packet according to the IP data packet, and extracts the IID of destination address in the header of the 6LoWPAN data packet, wherein the IID indicates the destination address of the 6LoWPAN data packet is the second node 2.

Then, in the step S412, the edge router 5 sends the extracted 6LoWPAN data packet to the second node 2.

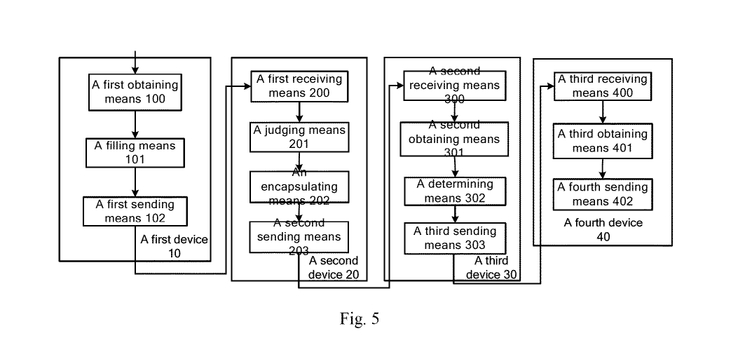

Hereinbefore, the present invention is described from the aspect of system method flow. Hereinafter, the present invention is described from the aspect of the device block diagram referring to FIG. 5.

Wherein, a first device 10 is located in the first node 1 and comprises a first obtaining means 100, a filling means 101 and a first sending means 102. A second device 20 is located in an edge router of the edge of the 6LoWPAN subnet in which the first node 1 is located. The second device 20 comprises a first receiving means 200, a judging means 201, an encapsulating means 202 and a second sending means 203. A third device 30 is located in a router of a backbone network. The third device 30 comprises a second receiving means 300, a second obtaining means 301, a determining means 302 and a third sending means 303. A fourth device 40 comprises a third receiving means 400, a third obtaining means 401 and a fourth sending means 402.

Firstly, the first obtaining means 100 obtains PAN IDs of the first node 1 and the second node 2 respectively.

Then, the filling means 101 fills the PAN IDs of the first node 1 and the second node 2 and 6LoWPAN-message-type information in a 6LoWPAN data packet, wherein the PAN ID of the first node 1 is used for indicating a source address of the 6LoWPAN data packet, the PAN ID of the second node 2 is used for indicating a destination address of the 6LoWPAN data packet, the 6LoWPAN-message-type information is used for identifying that the first node 1 and the second node 2 are located in different 6LoWPAN subnets.

Then, the first sending means 102 sends the filled 6LoWPAN data packet.

In a varied embodiment, the first obtaining means 100 is further used for obtaining IIDs of the first node and the second node.

Then, the filling means 101 is further used for filling the IIDs of the first node and the second node in a 6LoWPAN data packet, wherein the PAN ID and the IID of the first node is used for indicating the source address of the 6LoWPAN data packet, the PAN ID and the IID of the second node is used for indicating the destination address of the 6LoWPAN data packet.

In another embodiment, the first obtaining means 100 is further used for obtaining the PAN ID s of the first node and the second node according to an IPv6 address of the 6LoWPAN and obtaining the IIDs of the first node and the second node according to a data packet from a media access layer.

Then, the first receiving means 200 in the second device 20 receives the 6LoWPAN data packet from the first node;

Then, the judging means 201 judges whether the 6LoWPAN data packet is sent to another 6LoWPAN subnet, according to 6LoWPAN-message-type information in the 6LoWPAN data packet;

Then the encapsulating means 202 encapsulates the 6LoWPAN data packet in an IP data packet when the 6LoWPAN data packet is sent to another 6LoWPAN subnet;

Then, the second sending means 203 sends the encapsulated IP data packet to a next-hop network equipment.

Then, the second receiving means 300 in the third device 30 in the router of the backbone network receives an IP data packet from the 6LoWPAN subnet.

Then, the second de-capsulating means 301 de-capsulates the IP data packet to obtain a PAN ID of a destination address in the IP data packet.

Then, the determining means 302 determines a next-hop network equipment according to the PAN ID.

Then, the third sending means 303 forwards the IP data packet to the determined next-hop network equipment.

The third receiving means 400 in the fourth device 40 in an edge router of the edge of the 6LoWPAN subnet in which the second node 2 is located, receives the IP data packet from the backbone network.

Then, the third obtaining means 401 obtains a 6LoWPAN data packet encapsulated in the IP data packet according to the IP data packet, and extracts an IID of a destination address in a header of the 6LoWPAN data packet, wherein the IID indicates that the destination address of the 6LoWPAN data packet is a second node.

Then, the fourth sending means sends the 6LoWPAN data packet to the second node.

Embodiments of the present invention are described as above, but the present invention is not restricted to specific system, apparatus and detailed protocol, the skilled in the art can make a variety of variants or modification within the scope of the appended claims.

Those ordinary skilled in the art could understand and realize modifications to the disclosed embodiments, through studying the description, drawings and appended claims. The word “comprising” does not exclude the presence of elements or steps not listed in a claim or in the description. The word “a” or “an” preceding an element does not exclude the presence of a plurality of such elements. In the practice of present invention, several technical features in the claim can be embodied by one component. In the claims, any reference signs placed between parentheses shall not be construed as limiting the claim.

1. A method of communicating with a second node, in a first node of a 6LoWPAN subnet, wherein the method comprises:
A. obtaining personal area network identifiers of the first node and the second node respectively;
B. filling the personal area network identifiers of the first node and the second node and 6LoWPAN-message-type information in a 6LoWPAN data packet, wherein the personal area network identifier of the first node is used for indicating a source address of the 6LoWPAN data packet, the personal area network identifier of the second node is used for indicating a destination address of the 6LoWPAN data packet, the 6LoWPAN-message-type information is used for identifying that the first node and the second node are located in different 6LoWPAN subnets;
C. sending the filled 6LoWPAN data packet.

2. The method according to claim 1, wherein the step A further comprises:
obtaining interference identifiers of the first node and the second node;
the step B further comprises:
filling the interference identifiers of the first node and the second node in a 6LoWPAN data packet, wherein the personal area network identifier and the interface identifier of the first node is used for indicating the source address of the 6LoWPAN data packet, the personal area network identifier and the interface identifier of the second node is used for indicating the destination address of the 6LoWPAN data packet.

3. The method according to claim 2, wherein the step A further comprises:
obtaining the personal area network identifiers of the first node and the second node according to a IPv6 address of the 6LoWPAN and obtaining the interface identifiers of the first node and the second node according to a data packet from a media access layer.

4. A method of routing a 6LoWPAN data packet from a first node, in an edge router located at the edge of a 6LoWPAN subnet, wherein the method comprises
receiving the 6LoWPAN data packet from the first node;
judging whether the 6LoWPAN data packet is sent to another 6LoWPAN subnet, according to 6LoWPAN-message-type information in the 6LoWPAN data packet;
encapsulating the 6LoWPAN data packet in an IP data packet when the 6LoWPAN data packet is sent to another 6LoWPAN subnet;
sending the encapsulated IP data packet to a next-hop network equipment.

5. A method of routing a data packet from a 6LoWPAN subnet, in a router of a backbone network, wherein the method comprises
receiving an IP data packet from the 6LoWPAN subnet;
decapsulating the IP data packet to obtain a personal area network identifier of a destination address in the IP data packet;
determining a next-hop network equipment according to the personal area network identifier;
forwarding the IP data packet to the next-hop network equipment.

6. A method of routing an IP data packet from a backbone network, in an edge router located at the edge of a 6LoWPAN subnet, wherein the method comprises:
receiving the IP data packet from the backbone network;
obtaining a 6LoWPAN data packet encapsulated in the IP data packet according to the IP data packet, and extracting an interface identifier of a destination address in a header of the 6LoWPAN data packet, wherein the interface identifier indicates that the destination address of the 6LoWPAN data packet is a second node;
sending the 6LoWPAN data packet to the second node.

7. A first device for communicating with a second node, in a first node of a 6LoWPAN subnet, wherein the first device comprises:
a first obtaining means, for obtaining personal area network identifiers of the first node and the second node respectively;
a filling means, for filling the personal area network identifiers of the first node and the second node and 6LoWPAN-message-type information in a 6LoWPAN data packet, wherein the personal area network identifier of the first node is used for indicating a source address of the 6LoWPAN data packet, the personal area network identifier of the second node is used for indicating a destination address of the 6LoWPAN data packet, the 6LoWPAN-message-type information is used for identifying that the first node and the second node are located in different 6LoWPAN subnets;
a first sending means, for sending the filled 6LoWPAN data packet.

8. The first device according to claim 7, wherein the first obtaining means is further used for:
obtaining interference identifiers of the first node and the second node;
the filling means is further used for:
filling the interference identifiers of the first node and the second node in a 6LoWPAN data packet, wherein the personal area network identifier and the interface identifier of the first node is used for indicating the source address of the 6LoWPAN data packet, the personal area network identifier and the interface identifier of the second node is used for indicating the destination address of the 6LoWPAN data packet.

9. The first device according to claim 8, wherein the first obtaining means is further used for:
obtaining the personal area network identifiers of the first node and the second node according to a IPv6 address of the 6LoWPAN and obtaining the interface identifiers of the first node and the second node according to a data packet from a media access layer.

10. A second device for routing a 6LoWPAN data packet from a first node, in an edge router located at the edge of a 6LoWPAN subnet, wherein the second device comprises:
a first receiving means, for receiving the 6LoWPAN data packet from the first node;
a judging means, for judging whether the 6LoWPAN data packet is sent to another 6LoWPAN subnet, according to 6LoWPAN-message-type information in the 6LoWPAN data packet;
an encapsulating means, for encapsulating the 6LoWPAN data packet in an IP data packet when the 6LoWPAN data packet is sent to another 6LoWPAN subnet;
a second sending means, for sending the encapsulated IP data packet to a next-hop network equipment.

11. A third device for routing a data packet from a 6LoWPAN subnet, in a router of a backbone network, wherein the third device comprises:
a second receiving means, for receiving an IP data packet from the 6LoWPAN subnet;
a second obtaining means, for decapsulating the IP data packet to obtain a personal area network identifier of a destination address in the IP data packet;
a determining means, for determining a next-hop network equipment according to the personal area network identifier;
a third sending means, for forwarding the IP data packet to the next-hop network equipment.

12. A fourth device for routing an IP data packet from a backbone network, in an edge router located at the edge of a 6LoWPAN subnet, wherein the fourth device comprises:
a third receiving means, for receiving the IP data packet from the backbone network;
a third obtaining means, for obtaining a 6LoWPAN data packet encapsulated in the IP data packet according to the IP data packet, and extracting an interface identifier of a destination address in a header of the 6LoWPAN data packet, wherein the interface identifier indicates that the destination address of the 6LoWPAN data packet is a second node;
a fourth sending means, for sending the 6LoWPAN data packet to the second node.
